(19) United States
(12) Patent Application Publication
(10) Pub. No.: US 2015/0159737 A1
(43) Pub. Date: Jun. 11, 2015

(54) MULTI-SPEED TRANSMISSION

(71) Applicant: Ford Global Technologies, LLC, Dearborn, MI (US)

(72) Inventor: Gregory Daniel Goleski, Rochester Hills, MI (US)

(73) Assignee: Ford Global Technologies, LLC, Dearborn, MI (US)

(21) Appl. No.: 14/100,330

(22) Filed: Dec. 9, 2013

(51) Int. Cl. F16H 3/46

(52) U.S. Cl. CPC F16H 3/46; F16H 2200/201; F16H 2200/2041

(57) ABSTRACT

A family of transmission gearing arrangements produces nine forward speed ratios and one reverse speed ratio. Each arrangement includes a two state shift element. In a first state, the shift element passively holds a shaft against rotation in one direction while permitting rotation in the opposite direction. In a second state, the shift element holds the shaft against rotation in both directions. The shift element may be implemented as a combination of a one-way-brake and a dog clutch. Each arrangement also includes a gearing arrangement that produces three speed relationships between an input and an intermediate shaft, including an underdrive relationship, a reverse speed relationship, and holding the intermediate shaft against rotation.

### TECHNICAL FIELD

This disclosure relates to the field of automatic transmissions for motor vehicles. More particularly, the disclosure pertains to an arrangement of gears, clutches, and the interconnections among them in a power transmission.

### BACKGROUND

Many vehicles are used over a wide range of vehicle speeds, including both forward and reverse movement. Some types of engines, however, are capable of operating efficiently only within a narrow range of speeds. Consequently, transmissions capable of efficiently transmitting power at a variety of speed ratios are frequently employed. When the vehicle is at low speed, the transmission is usually operated at a high speed ratio such that it multiplies the engine torque for improved acceleration. At high vehicle speed, operating the transmission at a low speed ratio permits an engine speed associated with quiet, fuel efficient cruising. Typically, a transmission has a housing mounted to the vehicle structure, an input shaft driven by an engine crankshaft, and an output shaft driving the vehicle wheels, often via a differential assembly which permits the left and right wheel to rotate at slightly different speeds as the vehicle turns.

The various speed ratios are typically selected by engaging certain shift elements while other shift elements are dis-engaged. Different types of shift elements have different characteristics and properties. Automatic transmissions typically utilize a number of actively controlled friction clutches or brakes that transmit a torque between elements in response to a control signal such as a hydraulic pressure. A friction clutch or brake can transmit a controlled amount of torque even when the elements are at different speeds. However, friction clutches often transmit some parasitic torque even when disengaged. Positive engagement shift element such as dog clutches are actively controlled to be in either an engaged state or a disengaged state, but do not transfer torque between shafts that have relative rotation. Positive engagement shift elements typically exert less parasitic drag than a friction clutch of the same maximum torque capacity. Passive one way clutches permit relative rotation in one direction but allow relative rotation in the other direction. Some one way clutches can be actively controlled to enter alternative states such as preventing rotation in either direction or allowing rotation in either direction.

### BRIEF DESCRIPTION OF THE DRAWINGS

FIG. 1 is a schematic diagram of a first transmission gearing arrangement.

FIG. 2 is a schematic diagram of a second transmission gearing arrangement.

FIG. 3 is a schematic diagram of a third transmission gearing arrangement.

### SUMMARY OF THE DISCLOSURE

A transmission has an input, an output, first, second, and third shafts, and gearing arrangements and shift elements that impose particular speed relationships among them. A first gearing arrangement fixedly imposes a linear speed relationship among the first shaft, the second shaft, the output, and the third shaft. The first gearing arrangement may include, for example, two planetary gear sets with a first sun gear fixedly coupled to the third shaft, a first carrier and second ring gear fixedly coupled to the output, a first ring gear and second carrier fixedly coupled to the second shaft, and a second sun gear fixedly coupled to the first shaft. A second gearing arrangement alternately i) holds the first shaft against rotation, ii) establishes an underdrive relationship between the input and the first shaft, or iii) establishes a reverse speed relationship between the input and the first shaft. The second gearing arrangement may include, for example, two planetary gear sets with a third sun gear fixedly coupled to a fourth shaft, a third carrier and fourth carrier fixedly coupled to a fifth shaft, a third ring gear and fourth sun gear fixedly coupled to the input, and a fourth ring gear fixedly coupled to the first shaft, and three brakes selectively holding the first, fourth, and fifth shafts against rotation. As another example, the second gearing arrangement may include two planetary gear sets with a third sun gear fixedly coupled to a fourth shaft, a third carrier and fourth carrier fixedly coupled to a fifth shaft, a third ring gear and fourth sun gear fixedly coupled to a sixth shaft, and a fourth ring gear fixedly coupled to the first shaft, two brakes selectively holding the fourth and fifth shafts against rotation, and a clutch selectively coupling the sixth shaft to the input. As another example, the second gearing arrangement may be implemented with axis transfer gearing. A first shift element alternately i) passively restrains the second shaft from rotation in a reverse direction while permitting rotation in a forward direction or ii) holds the second shaft against rotation in either direction. Second and third shift elements selectively couple the input to the second and third shafts, respectively.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

A group of rotating elements are fixedly coupled to one another if they are constrained to rotate as a unit in all operating conditions. Rotating elements can be fixedly coupled by spline connections, welding, press fitting, machining from a common solid, or other means. Slight variations in rotational displacement between fixedly coupled elements can occur such as displacement due to lash or shaft compliance. One or more rotating elements that are all fixedly coupled to one another may be called a shaft. In contrast, two rotating elements are selectively coupled by a shift element when the shift element constrains them to rotate as a unit whenever it is fully engaged and they are free to rotate at distinct speeds in at least some other operating condition. A shift element that holds a rotating element against rotation by selectively connecting it to the housing is called a brake. A shift element that selectively couples two or more rotating elements to one another is called a clutch. Shift elements may be actively controlled devices such as hydraulically or electrically actuated clutches or brakes or may be passive devices such as one way clutches or brakes. Shift elements may be positive engagement devices such as dog clutches or friction devices capable of transmitting torque between elements in the presence of relative rotation. Two rotating elements are coupled if they are either fixedly coupled or selectively coupled.

A gearing arrangement is a collection of gearing elements and shift elements configured to impose specified speed relationships among a set of shafts. Some speed relationships, called fixed speed relationships, are imposed regardless of the state of any shift elements. Other speed relationships, called selective speed relationships, are imposed only when particular shift elements are fully engaged. The speed of a shaft is positive when the shaft rotates in one direction and negative when the shaft rotates in the opposite direction. A proportional speed relationship exists between a first shaft and a second shaft when the ratio of their speeds is constrained to be a predetermined value. A proportional speed relationship is a reverse speed relationship if the two shafts rotate in opposite directions. A proportional speed relationship between a first shaft and a second shaft is an underdrive relationship if the ratio of the second shaft speed to the first shaft speed is between zero and one. Similarly, a proportional speed relationship between a first shaft and a second shaft is an overdrive relationship if the ratio of the second shaft speed to the first shaft speed is greater than one. A linear speed relationship exists among an ordered list of shafts when i) the first and last shaft in the ordered list are constrained to have the most extreme speeds, ii) the speeds of the remaining shafts are each constrained to be a weighted average of the speeds of the first and last shafts, and iii) when the speeds of the shafts differ, they are constrained to be in the listed order, either increasing or decreasing.

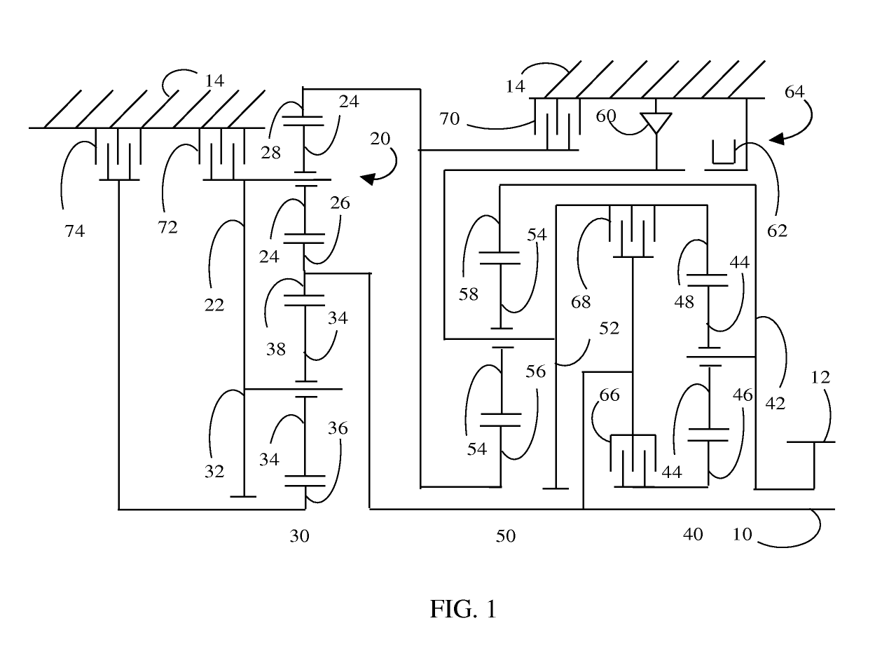

FIG. 1 depicts a transmission that provides nine forward and one reverse speed ratios between input 10 and output 12. Input 10 may be driven by an internal combustion engine or other prime mover. A launch device such as a torque converter or launch clutch may be employed between the prime mover and input 10 permitting the engine to idle while the vehicle is stationary and a transmission ratio is selected. Output 12 drives the vehicle wheels, preferably via a differential that allows a slight speed difference between left and right wheels while the vehicle goes around a corner. The transmission of FIG. 1 is depicted as a transversely mounted transaxle wherein output 12 transmits power to a differential on a parallel axis. For example, output 12 may be an axis transfer gear that transfers power to an axis transfer gear on the differential axis by way of axis transfer gears on an intermediate axis. Alternatively, output 12 may be a sprocket that transfers power to a sprocket on the differential axis via a chain.

The transmission of FIG. 1 utilizes four simple planetary gear sets 20, 30, 40, and 50. For example, planet carrier 52 rotates about a central axis and supports a set of planet gears 54 such that the planet gears rotate with respect to the planet carrier. External gear teeth on the planet gears mesh with external gear teeth on a sun gear 56 and with internal gear teeth on a ring gear 58. The sun gear and ring gear are supported to rotate about the same axis as the carrier. Gear sets 20, 30, and 40 are similarly structured. To reduce the axial length of the transmission, gear set 20 is located radially outside of gear set 30. A suggested ratio of gear teeth for each planetary gear set is listed in Table 1.

TABLE 1

| | |
|---|---|
| Ring 28/Sun 26 | 1.90 |
| Ring 38/Sun 36 | 2.60 |
| Ring 48/Sun 46 | 2.00 |
| Ring 58/Sun 56 | 2.45 |

A simple planetary gear set is a type of gearing arrangement that imposes a fixed linear speed relationship among the sun gear, the planet carrier, and the ring gear. Other known types of gearing arrangements also impose a fixed linear speed relationship among three rotating elements. For example, a double pinion planetary gear set imposes a fixed linear speed relationship among the sun gear, the ring gear, and the planet carrier.

Sun gear 26 and ring gear 38 are fixedly coupled to input 10. Ring gear 58 and carrier 42 are fixedly coupled to output 12. Ring gear 28 is fixedly coupled to sun gear 56 forming a first shaft. Ring gear 48 is fixedly coupled to carrier 52 forming a second shaft. Sun gear 46 forms a third shaft. Sun gear 36 forms a fourth shaft. Carrier 22 and carrier 32 are fixedly coupled forming a fifth shaft. Sun gear 26 and ring gear 38 are fixedly coupled forming a sixth shaft. Brakes 70, 72, and 74 selectively hold the first, fifth, and fourth shafts, respectively, against rotation. Clutches 66 and 68 selectively couple input shaft 10 to the third and second shafts, respectively.

One-way-brake 60 passively holds the second shaft against rotation in a reverse direction, opposite the normal rotation of input shaft 10, while permitting rotation in a positive direction. Dog clutch 62 is a positive engagement shift element that selectively holds the second shaft against rotation. One-way-brake 60 and dog clutch 62 collectively form a two-state shift element 64. The design of a dog clutch and one way clutch combination is discussed in U.S. patent application Ser. No. 13/714,929 which is incorporated by reference herein. In a first state, when dog clutch 62 is dis-engaged, shift element 64 passively restrains the second shaft from rotation in a reverse direction while permitting rotation in a forward direction. This first state is called locked-free in the remainder of the specification. In a second state, when dog clutch 62 is engaged, shift element 64 holds the second shaft against rotation in either direction. This second state is called locked-locked in the remainder of the specification. Other types of devices that alternately establish these two states may be substituted, including devices capable of establishing additional states such as free-locked or free-free.

Various subsets of the gearing arrangement of FIG. 1 impose particular speed relationships. Gear sets 40 and 50 collectively impose a linear speed relationship among the first shaft, the second shaft, the output, and the third shaft. Similarly, gear sets 20 and 30 collectively impose a linear speed relationship among the fourth shaft, the first shaft, the fifth shaft, and the input. Any gearing arrangement having two planetary gear sets with two elements of the first gear set fixedly coupled to two respective elements of the second gear set fixedly impose a linear speed relationship among the resulting four shafts. Gear sets 20 and 30 in combination with brakes 70, 72, and 74 alternately impose three speed relationships. When brake 70 is engaged, the first shaft is held against rotation. When brake 72 is engaged, a reverse speed relationship is established between the input and the first shaft. When brake 74 is engaged, an underdrive speed relationship is established between the input and the first shaft. Finally, gear set 40 and clutch 66 selectively impose a linear speed relationship among input 10, output 12, and the second shaft.

Engaging the shift elements as shown in Table 2 establishes nine forward speed ratios and one reverse speed ratio between input 10 and output 12. An X indicates that the shift element must be engaged to establish the power transfer path. When the gear sets have tooth numbers as indicated in Table 1, the speed ratios have the values indicated in Table 2.

TABLE 2

| | 64 | 66 | 68 | 70 | 72 | 74 | Ratio | Step |
|---|---|---|---|---|---|---|---|---|
| Rev | locked/locked | | | | | X | −4.25 | 91% |
| L-1^{st} | locked/locked | | | | X | | 4.66 | |
| D-1^{st} | locked/free | | | | X | | 4.66 | |
| L-2^{nd} | locked/locked | X | | | | | 3.00 | 1.55 |
| D-2^{nd} | locked/free | X | | | | | 3.00 | |
| 3^{rd} | locked/free | X | | | X | | 2.27 | 1.32 |
| 4^{th} | locked/free | X | | X | | | 1.58 | 1.44 |
| 5^{th} | locked/free | X | | | | X | 1.18 | 1.33 |
| 6^{th} | locked/free | X | X | | | | 1.00 | 1.18 |
| 7^{th} | locked/free | | X | | | X | 0.85 | 1.17 |
| 8^{th} | locked/free | | X | X | | | 0.71 | 1.20 |
| 9^{th} | locked/free | | X | | X | | 0.62 | 1.15 |

When the shift selector is moved into the Drive (D) position, the transmission is prepared for forward motion in 1st gear by engaging brake 72. One-way-brake 60 will passively engage to complete the power transfer path. Upon reaching a sufficient vehicle speed in 1st gear, the transmission is shifted into 2nd gear by gradually engaging clutch 66 and releasing brake 72. Ideally, brake 72 is released just as the torque capacity of clutch 66 reaches a level sufficient to transmit the input torque in 2nd gear. If brake 72 is released prematurely, then output torque will drop more than necessary and the input speed will rise quickly. This is known as a flare condition. If, on the other hand, brake 72 is released too late, output torque will drop more than necessary in what is called a tie-up condition. However, a tie-up condition will not reduce the output torque below the level associated with 3rd gear because one-way-brake 60 would begin to overrun at that point.

Upon reaching a sufficient vehicle speed in 2nd gear, the transmission is shifted into 3rd by gradually engaging brake 72. One-way-brake 60 will passively disengage when brake 72 reaches the proper torque capacity. Shifting from 3rd to 4th is accomplished by the coordinated engagement of brake 70 and release of brake 72. Shifting from 4th to 5th is accomplished by the coordinated engagement of brake 74 and release of brake 70. Shifting from 5th to 6th is accomplished by the coordinated engagement of clutch 68 and release of brake 74. Shifting from 6th to 7th is accomplished by the coordinated engagement of brake 74 and release of clutch 66. Shifting from 7th to 8th is accomplished by the coordinated engagement of brake 70 and release of brake 74. Finally, shifting from 8th to 9th is accomplished by the coordinated engagement of brake 72 and release of brake 70. Downshifts are accomplished by reversing the corresponding upshift. For example, downshifting from 8th gear to 7th gear is accomplished by the coordinated engagement of brake 74 and release of brake 70.

When the shift selector is in the Drive position, the transmission does not transmit power from output 12 to input 10 in 1st or 2nd gears because one-way-brake 60 would over-run. Thus, engine compression cannot be used to slow the vehicle. This is usually advantageous because engine braking in these ratios can result in sudden increases in deceleration if a downshift occurs at too high of a vehicle speed, causing discomfort to vehicle occupants. When the driver desires that engine compression slow the vehicle in these ratios, for example to control speed descending a steep hill, the driver selects the Low (L) operating range. In Low, the transmission is prepared for forward motion in 1st gear by engaging brake 72 and engaging dog clutch 62 to place shift element 64 in a locked/locked state. The passive engagement of one-way-brake 60 as brake 72 is engaged ensures that carrier 52 is stopped such that dog clutch 62 can be engaged. Upon reaching a sufficient vehicle speed in 1st gear, the transmission is shifted into 2nd gear by gradually engaging clutch 66 and releasing brake 72. Shift element 62 must be placed into the locked/free state by disengaging dog clutch 64 before the shift to 3rd gear is initiated.

When the shift selector is moved into the Reverse (R) position, the transmission is prepared for reverse motion by engaging dog clutch 62 to place shift element 64 in the locked/locked state and engaging brake 74. Preferably, the engagement of dog clutch 62 precedes the engagement of brake 74 because carrier 52 may start to accelerate as brake 74 is engaged making smooth engagement of dog clutch 62 difficult. If necessary, brake 72 or clutch 66 may briefly be partially engaged to stop any rotation of carrier 52. It may be desirable to leave dog clutch 62 engaged whenever the vehicle is in park, neutral, reverse, or in drive at low vehicle speed in order to avoid the need to ensure that carrier 52 is stopped before engaging the dog clutch.

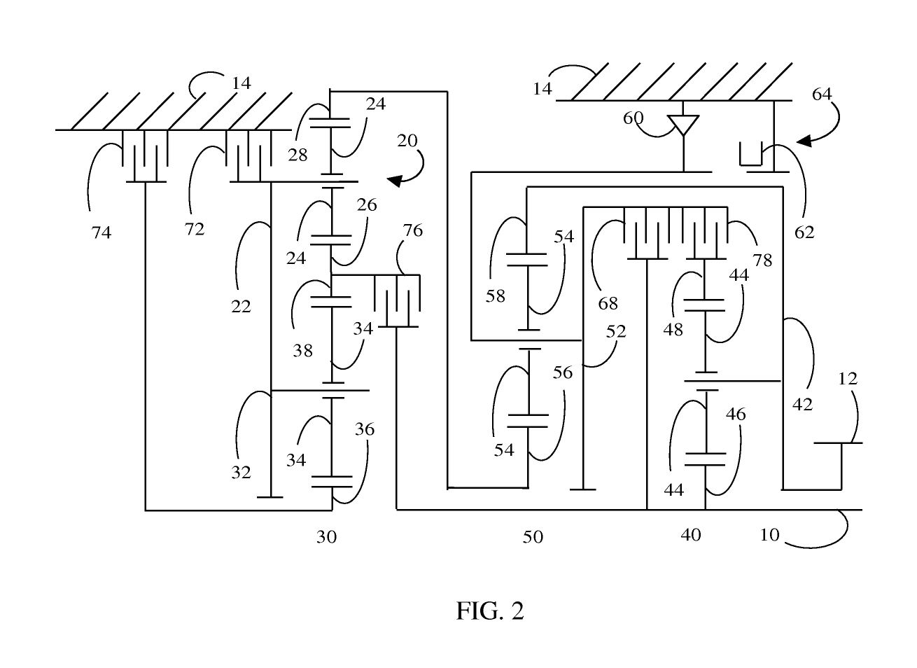

FIG. 2 depicts a transmission that provides nine forward and one reverse speed ratios between input 10 and output 12. The transmission of FIG. 2 utilizes four simple planetary gear sets 20, 30, 40, and 50. A suggested ratio of gear teeth for each planetary gear set is listed in Table 1.

Sun gear 46 is fixedly coupled to input 10. Ring gear 58 and carrier 42 are fixedly coupled to output 12. Ring gear 28 is fixedly coupled to sun gear 56 forming a first shaft. Carrier 52 forms a second shaft. Sun gear 36 forms a fourth shaft. Carrier 22 and carrier 32 are fixedly coupled forming a fifth shaft. Sun gear 26 and ring gear 38 are fixedly coupled forming a sixth shaft. Brakes 72 and 74 selectively hold the fifth, and fourth shafts, respectively, against rotation. Clutches 66, 68, and 76 selectively couple input shaft 10 to the third, second, and sixth shafts, respectively. Shift element 64 alternately holds the second shaft against rotation and passively holds the second shaft against rotation in a reverse direction while permitting rotation in a positive direction.

Various subsets of the gearing arrangement of FIG. 2 impose particular speed relationships. Gear sets 20 and 30 collectively impose a linear speed relationship among the fourth shaft, the first shaft, the fifth shaft, and the sixth shaft. Gear sets 20 and 30 in combination with shift elements 72, 74, and 76 alternately impose three speed relationships. When brakes 72 and 74 are both engaged, the first shaft is held against rotation. When brake 72 and clutch 76 are both engaged, a reverse speed relationship is established between the input and the first shaft. When brake 74 and clutch 76 are both engaged, an underdrive speed relationship is established between the input and the first shaft. Finally, gear set 40 and clutch 78 selectively impose a linear speed relationship among input 10, output 12, and the second shaft.

Engaging the shift elements as shown in Table 3 establishes nine forward speed ratios and one reverse speed ratio between input 10 and output 12. An X indicates that the shift element must be engaged to establish the power transfer path. An (X) indicates that the shift element may be engaged in that speed ratio but is not required to establish the power transfer path. For example, clutches 68 and 78 are sufficient to establish the power flow path associated with 6th gear. One of brake 72, brake 74, or clutch 76 may also be engaged. Engaging brake 74 is suggested because that permits making most shifts with only one oncoming and one offgoing shift element. When the gear sets have tooth numbers as indicated in Table 1, the speed ratios have the values indicated in Table 3.

TABLE 3

| | 64 | 68 | 72 | 74 | 76 | 78 | Ratio | Step |
|---|---|---|---|---|---|---|---|---|
| Rev | locked/locked | | | X | X | | −4.25 | 91% |
| L-1^{st} | locked/locked | | X | | X | | 4.66 | |
| D-1^{st} | locked/free | | X | | X | | 4.66 | |
| L-2^{nd} | locked/locked | | (X) | | | X | 3.00 | 1.55 |
| D-2^{nd} | locked/free | | (X) | | | X | 3.00 | |
| 3^{rd} | locked/free | | X | | X | X | 2.27 | 1.32 |
| 4^{th} | locked/free | | X | X | | X | 1.58 | 1.44 |
| 5^{th} | locked/free | | | X | X | X | 1.18 | 1.33 |
| 6^{th} | locked/free | X | | (X) | | X | 1.00 | 1.18 |
| 7^{th} | locked/free | X | | X | X | | 0.85 | 1.17 |
| 8^{th} | locked/free | X | X | X | | | 0.71 | 1.20 |
| 9^{th} | locked/free | X | X | | X | | 0.62 | 1.15 |

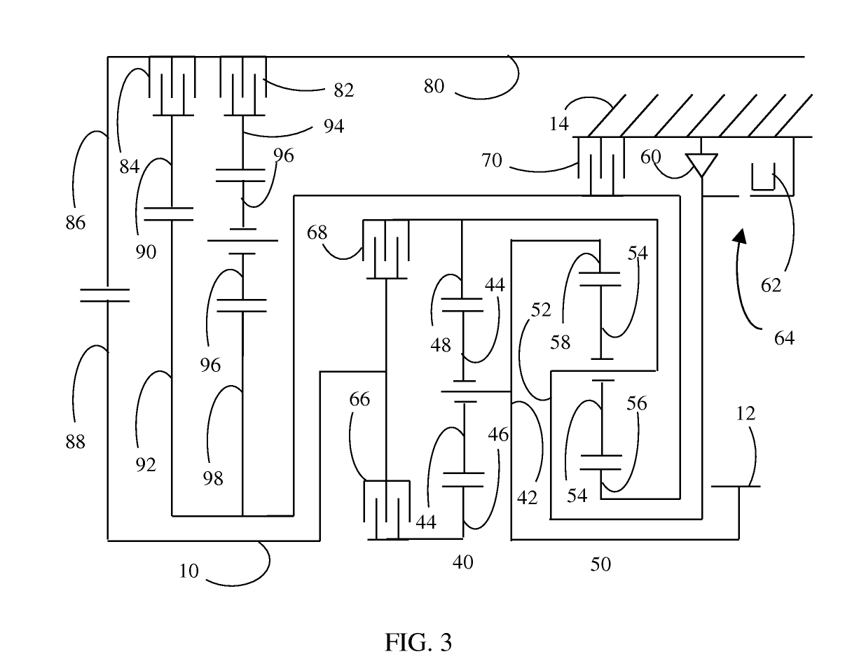

FIG. 3 depicts a transmission that provides nine forward and one reverse speed ratios between input 10 and output 12. The transmission of FIG. 3 utilizes two simple planetary gear sets 40 and 50 and three axis transfer gear sets. Input 10, output 12, and gear sets 40 and 50 may rotate about an intermediate axis that is offset from the engine crankshaft access. Shaft 80 may be coupled to the engine crankshaft, preferably via a launch device such as a torque converter or launch clutch. Axis transfer gear 86 is fixedly coupled to shaft 80 and in continuous meshing engagement with axis transfer gear 88 which is fixedly coupled to input 10. Ring gear 58 and carrier 42 are fixedly coupled to output 12. Output 12 may be an axis transfer gear that is in continuous meshing engagement with another axis transfer gear, not shown, to transfer power to the differential axis. Sun gear 56 forms a first shaft. Carrier 52 is fixedly coupled to ring gear 48 forming a second shaft. Sun gear 46 forms a third shaft. Axis transfer gears 90 and 94 are each supported for rotation about the axis of shaft 80. Axis transfer gear is fixedly coupled to the first shaft and in continuous meshing engagement with axis transfer gear 90. Axis transfer gear 98 is fixedly coupled to the first shaft. Idler gear 96 is in continuous meshing engagement with both axis transfer gear 94 and axis transfer gear 98. A suggested ratio of gear teeth for each gear set is listed in Table 4.

TABLE 4

| | |
|---|---|
| Gear 88/Gear 86 | 1.00 |
| Gear 92/Gear 90 | 1.74 |
| Gear 98/Gear 94 | 1.90 |
| Ring 48/Sun 46 | 2.00 |
| Ring 58/Sun 56 | 2.45 |

Brake 70 selectively holds the first shaft against rotation. Clutches 66 and 68 selectively couple input 10 to the third and second shafts, respectively. Clutches 82 and 84 selectively couple shaft 80 to axis transfer gears 94 and 90, respectively. Shift element 64 alternately holds the second shaft against rotation and passively holds the second shaft against rotation in a reverse direction while permitting rotation in a positive direction.

Various subsets of the gearing arrangement of FIG. 3 impose particular speed relationships. Axis transfer gears 86, 88, 90, 92, 94, 98, idler gear 96, shaft 80, and shift elements 70, 82, and 84 alternately impose three speed relationships. When brake 70 is engaged, the first shaft is held against rotation. When clutch 82 is engaged, a reverse speed relationship is established between the input and the first shaft. When clutch 84 is engaged, an underdrive speed relationship is established between the input and the first shaft. Next, gear sets 40 and 50 collectively impose a linear speed relationship among the first shaft, the second shaft, the output, and the third shaft. Finally, gear set 40 and clutch 66 selectively impose a linear speed relationship among input 10, output 12, and the second shaft.

Engaging the shift elements as shown in Table 5 establishes nine forward speed ratios and one reverse speed ratio between input 10 and output 12. An X indicates that the shift element must be engaged to establish the power transfer path. When the gear sets have tooth numbers as indicated in Table 4, the speed ratios have the values indicated in Table 5.

TABLE 5

| | 64 | 66 | 68 | 70 | 82 | 84 | Ratio | Step |
|---|---|---|---|---|---|---|---|---|
| Rev | locked/locked | | | | X | | −4.25 | 91% |
| L-1^{st} | locked/locked | | | | | X | 4.66 | |
| D-1^{st} | locked/free | | | | | X | 4.66 | |
| L-2^{nd} | locked/locked | X | | | | | 3.00 | 1.55 |
| D-2^{nd} | locked/free | X | | | | | 3.00 | |
| 3^{rd} | locked/free | X | | | | X | 2.27 | 1.32 |
| 4^{th} | locked/free | X | | X | | | 1.58 | 1.44 |
| 5^{th} | locked/free | X | | | X | | 1.18 | 1.33 |
| 6^{th} | locked/free | X | X | | | | 1.00 | 1.18 |
| 7^{th} | locked/free | | X | | X | | 0.85 | 1.17 |
| 8^{th} | locked/free | | X | X | | | 0.71 | 1.20 |
| 9^{th} | locked/free | | X | | | X | 0.62 | 1.15 |

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. A transmission comprising:
an input;
an output;
first, second, and third shafts;
a first gearing arrangement configured to fixedly impose a linear speed relationship among the first shaft, the second shaft, the output, and the third shaft;
a second gearing arrangement configured to alternately i) hold the first shaft against rotation, ii) establish an underdrive relationship between the input and the first shaft, and iii) establish a reverse speed relationship between the input and the first shaft;
a first shift element comprising a passive one-way-clutch between a transmission housing and the second shaft and a dog clutch configured to selectively couple the second shaft to the transmission housing;
a second shift element configured to selectively coupled the input to the second shaft; and
a third shift element configured to selectively couple the input to the third shaft.

2. The transmission of claim 1 wherein the first gearing arrangement comprises:
a first simple planetary gear set having a first sun gear fixedly coupled to the third shaft, a first carrier fixedly coupled to the output, and a first ring gear fixedly coupled to the second shaft; and
a second simple planetary gear set having a second sun gear fixedly coupled to the first shaft, a second carrier fixedly coupled to the second shaft and the first ring gear, and a second ring gear fixedly coupled to the output and the first carrier.

3. The transmission of claim 1 wherein the second gearing arrangement comprises:
fourth and fifth shafts;
a third gearing arrangement configured to fixedly impose a linear speed relationship among the fourth shaft, the first shaft, the fifth shaft, and the input;
a fourth shift element configured to selectively hold the first shaft against rotation;
a fifth shift element configured to selectively hold the fifth shaft against rotation; and
a sixth shift element configured to selectively hold the fourth shaft against rotation.

4. The transmission of claim 3 wherein the third gearing arrangement comprises:
a third simple planetary gear set having a third sun gear fixedly coupled to the fourth shaft, a third carrier fixedly coupled to the fifth shaft, and a third ring gear fixedly coupled to the input; and
a fourth simple planetary gear set having a fourth sun gear fixedly coupled to the input and the third ring gear, a fourth carrier fixedly coupled to the fifth shaft and the third carrier, and a fourth ring gear fixedly coupled to the first shaft.

5. The transmission of claim 4 wherein the fourth simple planetary gear set is located radially outside the third simple planetary gear set.

6. The transmission of claim 1 wherein the second gearing arrangement comprises:
a first axis transfer gear fixedly coupled to the input;
a second axis transfer gear in continuous meshing engagement with the first axis transfer gear;
a third axis transfer gear selectively coupled to the second axis transfer gear;
a fourth axis transfer gear fixedly coupled to the first shaft and in continuous meshing engagement with the third axis transfer gear;
a fifth axis transfer gear selectively coupled to the second axis transfer gear;
a sixth axis transfer gear fixedly coupled to the first shaft; and
an idler gear in continuous meshing engagement with both the fifth axis transfer gear and the sixth axis transfer gear.

7. (canceled)

8. A transmission comprising:
an input;
an output;
first and second shafts;
a first gearing arrangement configured to fixedly impose a linear speed relationship among the first shaft, the second shaft, and the output;
a second gearing arrangement configured to selectively impose a linear speed relationship among the input, the output, and the second shaft;
a third gearing arrangement configured to alternately i) hold the first shaft against rotation, ii) establish an underdrive relationship between the input and the first shaft, and iii) establish a reverse speed relationship between the input and the first shaft;
a first shift element comprising a passive one-way-clutch between a transmission housing and the second shaft and a dog clutch configured to selectively couple the second shaft to the transmission housing; and
a second shift element configured to selectively couple the input to the second shaft.

9. The transmission of claim 8 wherein the first gearing arrangement comprises a simple planetary gear set having a sun gear fixedly coupled to the first shaft, a carrier fixedly coupled to the second shaft, and a ring gear fixedly coupled to the output.

10. The transmission of claim 8 wherein the second gearing arrangement comprises:
a simple planetary gear set having a sun gear, a carrier fixedly coupled to the output, and a ring gear fixedly coupled to the second shaft; and
a clutch configured to selectively couple the sun gear to the input.

11. The transmission of claim 8 wherein the second gearing arrangement comprises:
a simple planetary gear set having a sun gear fixedly coupled to the input, a carrier fixedly coupled to the output, and a ring gear; and
a clutch configured to selectively couple the ring gear to the second shaft.

12. The transmission of claim 8 wherein the third gearing arrangement comprises:
fourth, fifth, and sixth shafts;
a fourth gearing arrangement configured to fixedly impose a linear speed relationship among the fourth shaft, the first shaft, the fifth shaft, and the sixth shaft;
a fourth shift element configured to selectively couple the sixth shaft to the input;
a fifth shift element configured to selectively hold the fifth shaft against rotation; and
a sixth shift element configured to selectively hold the fourth shaft against rotation.

13. The transmission of claim 12 wherein the fourth gearing arrangement comprises:
a third simple planetary gear set having a third sun gear fixedly coupled to the fourth shaft, a third carrier fixedly coupled to the fifth shaft, and a third ring gear fixedly coupled to the sixth shaft; and
a fourth simple planetary gear set having a fourth sun gear fixedly coupled to the sixth shaft and the third ring gear, a fourth carrier fixedly coupled to the fifth shaft and the third carrier, and a fourth ring gear fixedly coupled to the first shaft.

14. The transmission of claim 13 wherein the fourth simple planetary gear set is located radially outside the third simple planetary gear set.

15-19. (canceled)
